(19) United States
(12) Patent Application Publication
(10) Pub. No.: US 2010/0056331 A1
(43) Pub. Date: Mar. 4, 2010

(54) CONTROL DEVICE FOR OPERATING A GEAR BOX OF A VEHICLE, A SYSTEM FOR GEAR SHIFT AND PARKING BRAKE ACTUATION AND A VEHICLE COMPRISING A CONTROL DEVICE AND A SYSTEM

(75) Inventors: Lars Johansson, Satila (SE); Mikael Karlsson, Savedalen (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 12/530,246

(22) PCT Filed: Mar. 19, 2008
(86) PCT No.: PCT/SE08/00209

§ 371 Date: Sep. 8, 2009

(30) Foreign Application Priority Data
Mar. 26, 2007 (SE) 0700764-4

(51) Int. Cl. B60W 10/00; B60W 10/10; B60W 10/18

(52) U.S. Cl. 477/92

(57) ABSTRACT

A control device for operating a gear box of a vehicle includes a selector for selection of two or more gear positions and for selection of a parking brake position. The parking brake position includes a first operating region which is adapted to gradually apply a parking brake and a second operating region which is adapted to fully apply a parking brake.

### BACKGROUND AND SUMMARY

The present invention relates to a control device for operating a gear box of a vehicle, and to a system for gear shift and parking brake actuation.

The invention can be applied in a vehicle equipped with for example an automatic or semi-automatic gear box. The invention is applicable on heavy vehicles, such as trucks and busses. The invention is, however, not restricted to trucks and busses, but may also be used in industrial vehicles, such as wheel loaders and articulated haulers.

In heavy vehicles, such as trucks and busses, a parking brake control device used to apply the parking brake is normally positioned in the dashboard of the vehicle in a position where it is easy to reach for the driver. Heavy vehicles can be equipped with air actuated brakes which have at least some spring brake cylinders comprising a spring-loaded section. The parking brake is applied when the air is evacuated from the spring loaded section of the spring brake cylinder.

A gear selector for operating a gear box is normally situated beside the driver's seat. The gear selector on a heavy vehicle comprises several positions, including a low gear position, a manual position, an automatic position, a neutral position and a reverse position. Further functions include e.g. a split switch, an up/down-shift switch, an economy/performance switch and others.

U.S. Pat. No. 5,722,517 describes a gear selector lever having a parking position in which the parking brake is applied. The parking brake control valve comprises a first state wherein the parking brake is not applied and a second state wherein the parking brake is applied. However, this brake apparatus cannot fulfil the needs for the use in a modern heavy vehicle where the gear selector and the parking brake control device have to be easily accessible and easy to operate.

It is desirable to provide a control device of the kind referred to in the introduction, which control device can contribute to an improved driving performance of a vehicle and/or an improved environment to the driver of a vehicle.

By the provision of a control device wherein the operation of both a gear box and a parking brake is accomplished by means of one and the same selector means, and wherein the selector means can be brought into a parking brake position which has a first operating region which is adapted to gradually apply a parking brake and a second operating region which is adapted to fully apply a parking brake, the operation of different functions of a vehicle can be facilitated. This in turn can result in increased driving safety as well as better ergonomics for the driver. The product cost of the components may also be reduced.

The invention allows for an easier handling of the parking brake, since the driver has to operate only the selector means for both functions, and, thus the driver does not need to operate a separate control means for the parking brake function. Furthermore, since the parking brake can be applied gradually and preferably from zero to fully applied in the first operating region, it is possible to use the parking brake as an emergency brake in a naturally way by actuating the selector means in the first operating region of the parking position mode.

In a preferred embodiment of the control device according to the invention, the regions of the parking brake position can only be reached by actuating a control means, such as a position release button. This makes sure that the parking brake is not applied by accident.

In a further preferred embodiment of the control device according to the invention, the selector means is adapted to be arranged in a position in the vicinity of the steering wheel of a vehicle. The selector means is preferably adapted to be arranged in a vehicle in such a way that the selector means can be operated by a driver of the vehicle while keeping the hands on the steering wheel of the vehicle. This can be achieved by such a selector means which is adapted to be arranged in the steering column of a vehicle. An arrangement wherein the selector means is arranged adjacent or in close vicinity of the steering wheel, enables the driver both to change gear and to apply the parking brake by the use of a single control means without taking the hands off the steering wheel. This is a very advantageous feature for example in case of an emergence situation where the driver has to use the parking brakes as an emergency brake.

Furthermore, the integration of the parking brake function in the selector means implies that the space around the steering wheel is not limited to the extent as it would have been if two separate control means had been installed.

In a further embodiment of the control device according to the invention, in addition to the gear positions and the parking brake position the control device comprises a further function selectable by means of the selector means. The selector means can have for example a selectable position for operating a supplementary brake, such as a retarder brake. By means of such a selector means today's retarder brake lever, which is often situated in a position such that the driver has to reach for it to be able to use it, can be replaced. This will further improve the driving performance and an increased use of the retarder function can be expected.

In a further embodiment of the control device according to the invention, the control device comprises a detector means arranged to sense the position of the selector means in the first operating region. By the use of a detector means which is pneumatic it possible to integrate the control device in a fully pneumatic air brake system.

By the use of an electrical detector means a smaller control device and an easier installation thereof can be achieved, particularly if a foldable selector means is used.

The invention also relates to system for gear shift and parking brake actuation, comprising a parking brake actuating means and a control device according to the invention. The parking brake actuating means is preferably adapted to be applied on one or more wheels of a vehicle so as to obtain the parking brake function. The parking brake actuation means, when being in an activated condition, can advantageously be arranged to be released only if a service brake of the vehicle is applied.

The invention also relates to a vehicle, such as truck, which vehicle is provided with a control device according to the invention.

It should be stressed that the system for gear shift and parking brake actuation, as well as the vehicle can be provided with various control devices covering all different embodiments and features, and combinations thereof, of the control devices described herein.

Further advantages and advantageous features of the invention are disclosed in the following description and the dependent claims.

### BRIEF DESCRIPTION OF THE DRAWINGS

With reference to the appended drawings, below follows a more detailed description of embodiments of the invention cited as examples.

In the drawings:

FIGS. 1a and 1b are perspective views of a driving compartment of a vehicle comprising a control device according to the invention,

FIG. 2 is a perspective view of a control device according to the invention,

FIG. 3 is a side view of the control device in FIG. 2,

FIG. 4 is a schematic system using the control device according to the invention,

FIGS. 5a, 5b, 5c, 6a and 6b are variants of the control device according to the invention, and

FIG. 7 is a further variant of the control device according to the invention.

### DETAILED DESCRIPTION

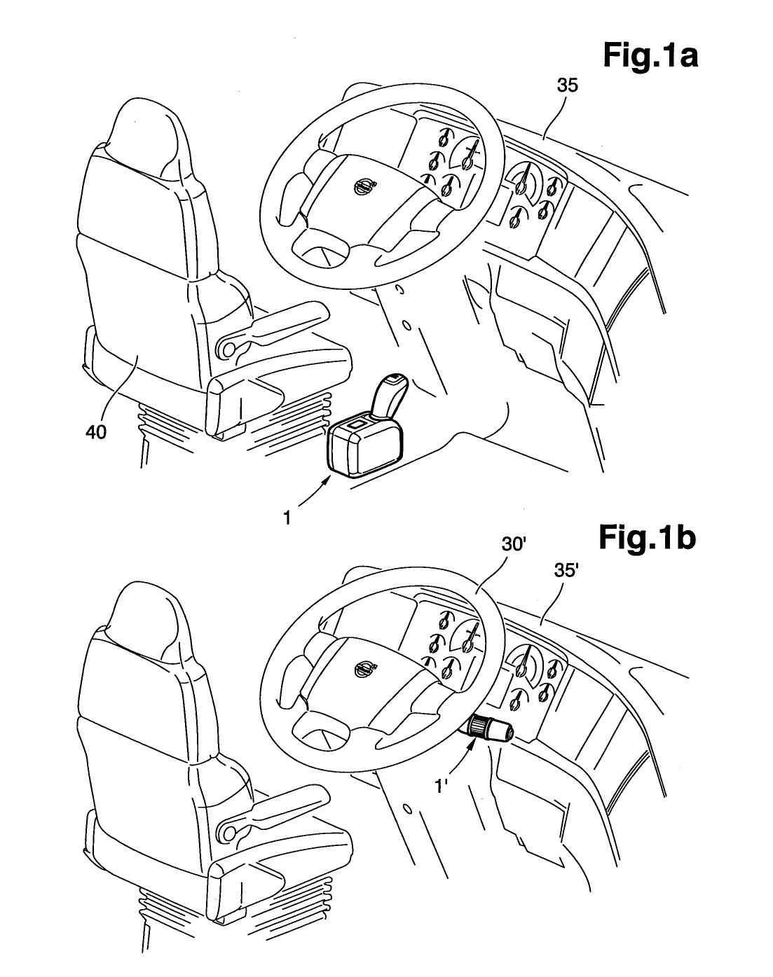

In FIG. 1a a driving compartment of a vehicle 35 is illustrated. The driving compartment is provided with a control device 1 for operating a gear box. The control device 1 is designed according to a first aspect of the invention and arranged adjacent to the driver's seat 40. In FIG. 1b a driving compartment of a vehicle 35′ is illustrated. The driving compartment is provided with a control device 1′ for operating a gear box. The control device V is designed according to a second aspect of the invention and arranged adjacent to the steering wheel 30′ on the steering column of the vehicle 35′.

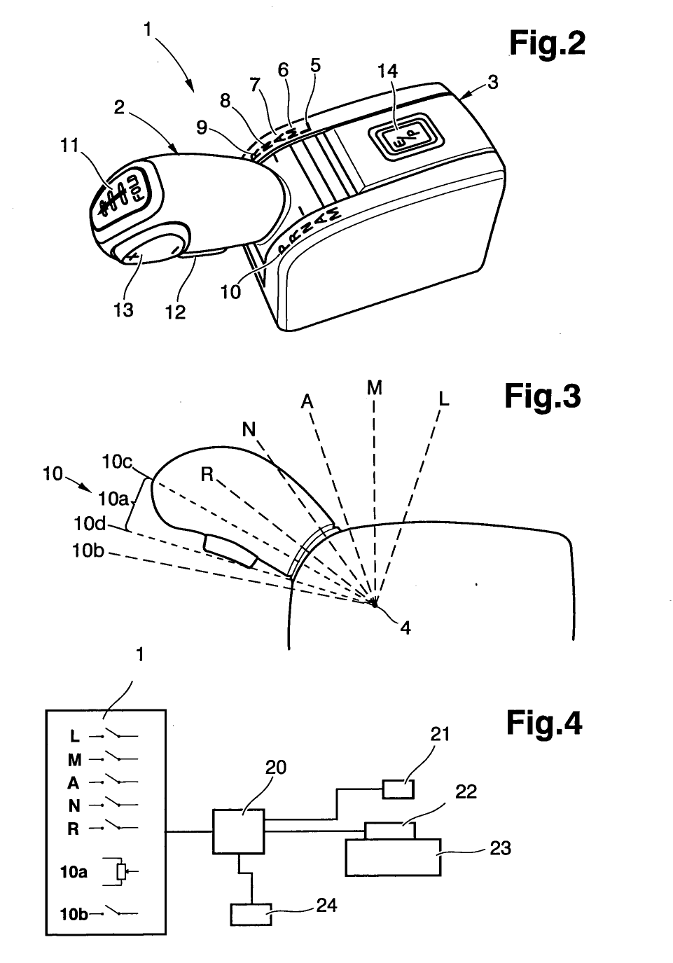

FIG. 2 shows a first embodiment of a control device 1 for operating a gear box of a vehicle according to the invention. The control device comprises a selector means 2. Although in this example the selector means is a gear lever 2, also other selector means such as buttons, rotary rings etc. are possible. In FIG. 2 the gear lever is pivotally mounted in a housing 3. The selector means 2 is provided for selection of two or more gear positions. The gear positions can include a low position 5, a manual position 6, an automatic position 7, a neutral position 8, and a reverse position 9. In accordance with the invention also a parking brake position 10 can be selected by means of the selector means 2. Further functions can be provided by buttons arranged on the gear lever 2 or the housing 3, such as an up/down shift switch 13, a fold switch 11 and a position release button 12. In the example illustrated in FIG. 1 the housing 3 includes an economy/performance switch 14.

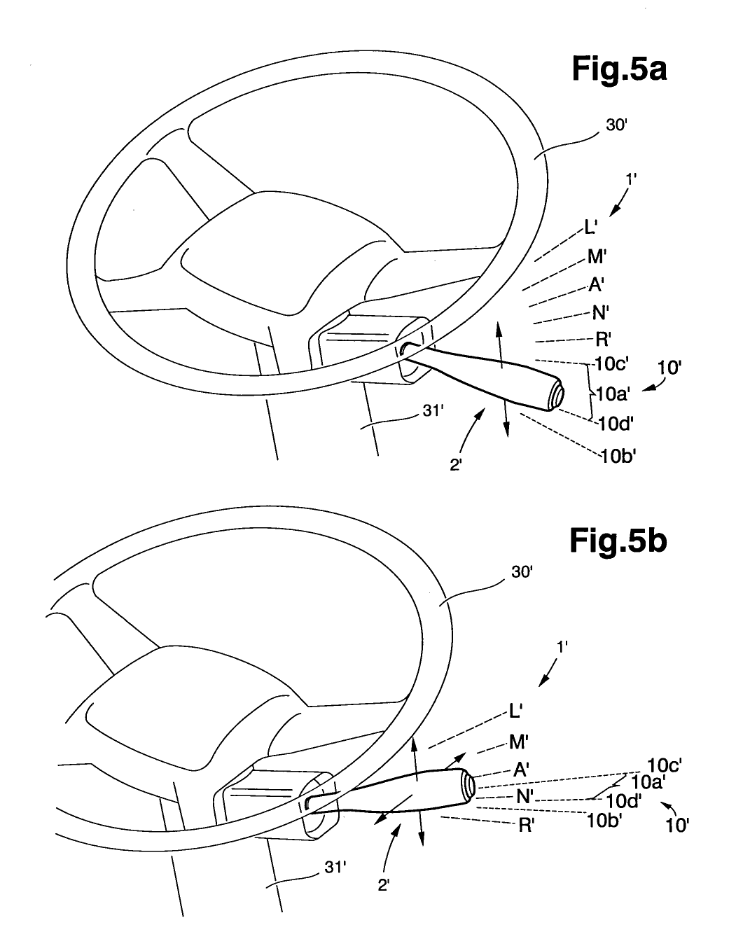

As illustrated in FIG. 3 the parking brake position 10 comprises a first operating region 10a which is adapted to gradually apply a parking brake and a second operating region 10b which is adapted to fully apply a parking brake. The gear lever 2 is pivotally mounted so as to be pivoted around a pivot axis 4. When the control device 1 is mounted in a vehicle, the pivot axis 4 extends in a substantially horizontal direction which direction is preferably substantially perpendicular to the travel direction of the vehicle.

In the low position 5, the low gears of the gear box are used and these are selected manually. The driver can shift between the low gears, e.g. gears 1 to 3, with the shift switch. These gears are sometimes referred to as crawl gears.

In the manual position 6, the driver selects the gear manually and the gear box control unit will engage the chosen gear if e.g. the speed of the vehicle is within the speed range of the selected gear. The speed range of a gear is preferably a predefined range defined for each gear in order to avoid damage to the gear box or the engine when selecting a gear outside of the allowed range.

In the automatic position 7, the control system of the vehicle shifts gears automatically, taking account on e.g. speed of the vehicle, load of the vehicle or the vehicle combination, engine speed etc. The driver may temporarily override the gear selected by the control system of the vehicle, e.g. to set the engine to a higher speed in order for a primary auxiliary brake to produce a higher brake torque. The selected gear will be engaged if e.g. the speed of the vehicle is within the speed range of the selected gear. This range is selected so that the gear box or the engine will not be damaged by the gear override.

In the neutral position 8, the gears are disengaged. To move the gear lever from the neutral position, the position release button 12 must be pressed. This is to avoid accidental engagement of a gear. In the reverse position 9, the reverse gear is selected.

The up/down-shift switch 13 is used by the driver to shift gear up or down. This can be used both in manual and automatic mode. The fold switch 11 is used to fold the complete gear lever 2 out of the way. This can only be done when the vehicle is parked. The position release button 12 is used to release the gear lever 2 so that the lever can be moved from one position to another. This is to protect the gear lever 2 from being moved accidentally. Between some positions, the gear lever may be moved without using the position release button, e.g. between the manual and automatic position, since the gear box control unit controls the allowed gear.

In the embodiment illustrated in FIGS. 2 and 3 the parking position 10 is reached by pressing the position release button 12 and simultaneously moving the gear lever 2 to the parking position 10 beyond the reverse position 9. The parking position 10 comprises said two operating regions; the first operating region 10a in which the parking brake can be gradually applied and the second operating region 10b in which the parking brake can be fully applied. The first operating region 10a starts just after the reverse position and continues to the second operating region 10b. As previously described the gear lever 2 can be pivoted about said pivot axis 4 relative to the housing 3, and the first operating region 10a corresponds to an angle interval in which the gear lever 2 can be positioned. A useful value of the angle interval for the first operating region is in the range of 10 to 30 degrees.

The first operating region starts at 10c. At this position, the braking force applied by the parking brake is suitably close to zero or zero, i.e. the parking brake is not applied. By moving the lever in the direction towards the end 10d of the region, the parking brake will be gradually applied, i.e. the braking force applied by the parking brake will raise until it is fully applied at 10d.

In the first operating region 10a, the gear lever 2 may be moved backwards and forwards in order to regulate the braking force applied by the parking brake. The gear lever 2 is preferable spring-loaded so that the driver receives some feedback and so that the gear lever 2 returns to position 10c when released.

By moving the gear lever 2 from 10d to 10b, the gear lever will be locked in this position and the parking brake will be fully applied. In this mode, the spring loaded section of the spring brakes cylinder of air actuated brakes will be completely evacuated. The control device can comprise a control means, for example a button to be actuated so as to allow a movement of the gear selector means 2 from the first operating region 10a to the second operating region 10b. In this example, the position release button 12 has to be pressed to reach the locked position in the second operating region 10b by movement of the gear lever 2 from the first operating region 10a.

The current angle position of the gear lever 2, when being situated in the parking brake position, is transferred to an actuator of the parking brake so as to apply the parking brake in accordance therewith. The detection of the position of the gear lever 2 may be mechanical, pneumatic, hydraulic or electrical.

If a mechanical detector means is used, mechanical operating means can incorporate levers and/or wires to transfer the movement of the gear lever to the parking brake actuators.

If a pneumatic detector means is used, pneumatic operating means can incorporate an air valve having a variable air pressure output. A pneumatic detector means is preferable used when legislative regulations require the air brake system to be directly coupled to the parking brake actuators.

If an electrical detector means is used in an electrical operating system, the detector means, which is arranged to sense the position of the gear lever, sends a signal to a control unit of the vehicle indicating when and how much the parking brake should be applied. This function may be integrated in e.g. the gear box control unit or in a brake control unit. The signal may be either analogue or digital, depending e.g. on the used sensors.

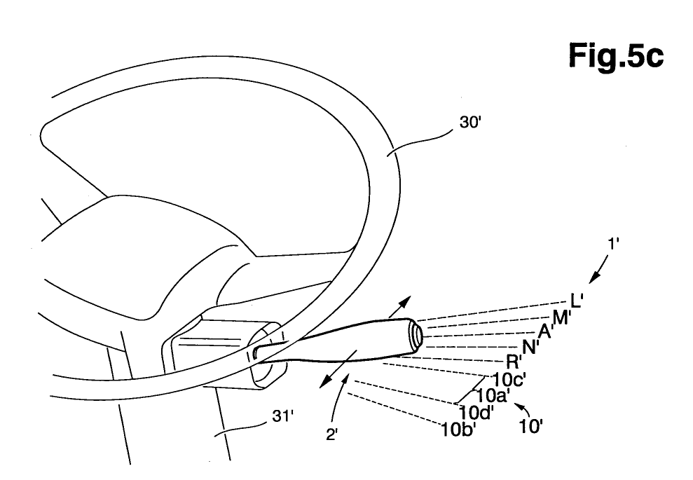

FIG. 4 shows a schematic system in which the control device according to the invention is used. The system comprises a control device 1 having a selector means connected to a suitable control unit. In this case the selector means is connected to a gear box control unit 20 of a vehicle. The gear box control unit 20 sends signals corresponding to the shift positions to the gear box actuator module 22 mounted on the gear box 23. The gear box actuator module 22 actuates the gears in the gear box. The gear box control unit 20 sends the signals corresponding to the parking brake position to the parking brake actuator 21 that applies the parking brake accordingly. In this schematic example, the gear shift positions are detected by switches and the position in the first operating region of the parking brake mode is detected by a potentiometer.

The means used to detect the gear shift positions and the position in the first operating region may be any suitable means. Switches may be electromechanical or contact-less using magnetic or optical technique.

The sensor for the position in the first operating region may also be a variable resistor, e.g. a potentiometer, a mechanical or optical pulse generator or a magnetic contact-less angle sensor with an electrical output signal. In an embodiment where the selector means in the form of a gear lever can rotate around a single pivot axis, an angular sensor is a preferred sensor. When using an angular sensor, a gear ratio may be advantageous to increase the resolution of the sensor. The choice of the sensor is partly governed by the type of control unit used for the parking brake system, i.e. if there are analogue or digital inputs available.

If the gear positions are detected by electrical switches that send signals to the gear box control unit, it is advantageous to use an electrical sensor to detect the position of the gear lever in the parking brake position as well. By doing this, there is no need for an air valve to be integrated into the control device. This saves space and facilitates the interface to the gear selector means, especially when the selector means is of the folding type.

When an electric sensor is used to detect the position of the gear lever in the first operating region, the parking brake actuator is controlled by an electric air valve that is continuously controllable. During the first operating region, the valve will regulate the pressure in the spring loaded section of the spring brakes cylinder continuously depending on the position of the gear lever. When the gear lever is moved to the second operating region, the air will be completely evacuated from the spring loaded section of the spring brakes cylinder. The valve is preferably spring-loaded towards an open position so that the parking brake will evacuate if there is an electrical power failure in the system.

In a further embodiment, a brake switch 24 for the service brake is incorporated in the system. This brake switch indicates that the service brake is applied, i.e. that the driver has pressed the brake pedal. The system will only release the parking brake when this switch indicates that the service brake is applied. This is to ensure that there are some brakes applied when the parking brake is released in order to make sure that the vehicle will not start to roll when the parking brake is released and the driver sets the selector means in e.g. neutral.

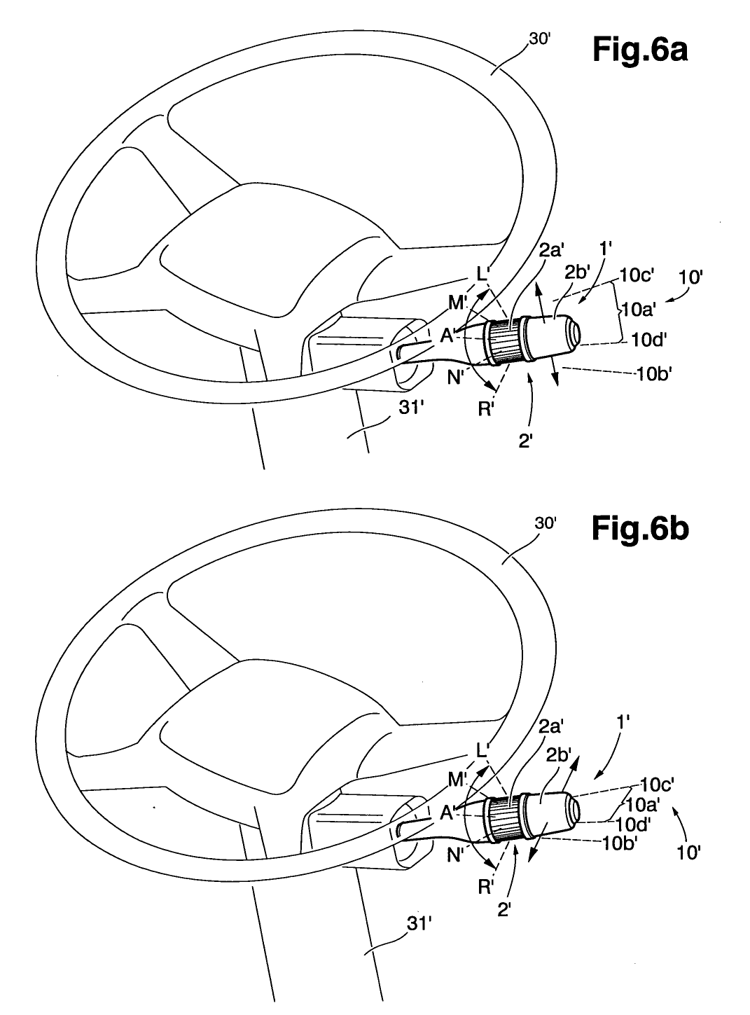

In FIGS. 5a, 5b, 5c, 6a, 6b, and 7 variants of the control device for operating a gear box of a vehicle according to the invention are illustrated. All functions described with respect to the embodiments in FIG. 2-4 as regards different gear positions and the parking position having the first and second regions can be applied in the following embodiments. These embodiments are different in the design and position of the selector means.

The control device comprises a selector means 2′ for selection of two or more gear positions L′, M′, A′, N′, R′ and for selection of a parking brake position 10′. The selector means 2′ is arranged in a position close to the steering wheel 30′ of a vehicle. An arrangement of the selector means in the vicinity of the steering wheel enables the driver both to change gear and to apply the parking brake by the use of a single control means without taking the hands off the steering wheel. Further in the embodiments illustrated in FIGS. 5a, 5b and 5c the selector means is a lever which is pivotally arranged adjacent to the steering wheel 30′ of the vehicle, and the lever is preferably arranged in the steering column 31′ of the vehicle. The gear positions and the parking position can be arranged in series, substantially vertically as illustrated in FIG. 5a or substantially horizontally as illustrated in FIG. 5c, or be separated by using for example two different pivot directions of the lever as illustrated in FIG. 5b. For example, as illustrated in FIG. 5a, the different gear positions can be situated so as to be reached when the lever is moved upwardly from a substantially horizontal position, and the brake parking position can be situated so as to be reached when the lever is moved downwardly from the substantially horizontal position.

In the variant according to FIG. 5b, the gear positions can be reached by moving the lever in the up and down direction, i.e. substantially in the vertical direction, whereas the parking brake operation is accomplished by moving the lever in the forward and backward direction, i.e. substantially in the horizontal direction.

In FIGS. 6a and 6b the selector means 2′ comprises a gear selector means 2a′ and a parking brake selector means 2b′. The gear selector means 2a′ and the parking brake selector means 2b′ are mechanically integrated with each other. This implies the gear selector means and the parking brake selector means are mechanically connected to each other, or manufactured in one piece, and, thus both said selector means 2a′, 2b′ are provided in one and the same control component.

The parking brake selector means 2b′ is preferably a lever pivotally arranged for selection of the parking brake position 10′. As previously described herein the parking position 10′ can comprise said two operating regions; the first operating region 10a′ in which the parking brake can be gradually applied and the second operating region 10b′ in which the parking brake can be fully applied. Furthermore, in the embodiments illustrated in FIGS. 6a and 6b the gear selector means 2a′ is a component which is pivotally arranged relative to the parking brake selector means 2b′ for selection of said two or more gear positions L′, M′, A′, N′, and R′. The gear selector means 2a′ may preferably be a ring which is pivotally arranged on the lever for pivoting around an axis which axis substantially coincides with the longitudinal axis of the lever. In FIG. 6a the parking brake selector means 2b′ provides the positions for operation the parking brake along a substantially vertical plan, whereas in FIG. 6b the parking selector means 2b′ provides the positions for operation the parking brake along a substantially horizontal plan.

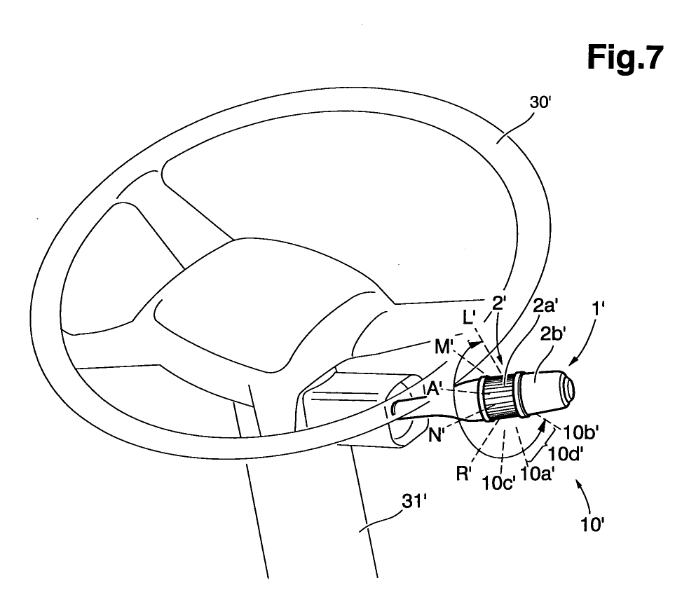

In FIG. 7 a further embodiment of the invention is illustrated. In this example both the gear positions and the parking brake position with associated regions are arranged in a ring which is pivotally arranged on a lever. The lever can be fixed or be pivotally connected to the steering column, for instance, for providing other functions, such as a retarder brake.

It is to be understood that the present invention is not limited to the embodiments described above and illustrated in the drawings; rather, the skilled person will recognize that many changes and modifications may be made within the scope of the appended claims. The control device can also be adapted to be arranged in other positions, for example in a dash board of a vehicle.

1. A control device for operating a gear box of a vehicle, comprising a selector means for selection of two or more gear positions and for selection of a parking brake position, wherein the parking brake position comprises a first operating region which is adapted to gradually apply a parking brake and a second operating region which is adapted to fully apply a parking brake.

2. A control device according to claim 1, wherein the first operating region is arranged to control the braking force of the parking brake from zero at a first point of the first region to full braking force at a second point of the first region.

3. A control device according to claim 1, wherein the control device comprises a control means, such as a button to be actuated so as to allow a movement of the selector means from a position corresponding to the first operating region to a position corresponding the second operating region.

4. A control device according to claim 1, wherein the selector means is adapted to be arranged in a position in the vicinity of the steering wheel of a vehicle.

5. A control device according to claim 1, wherein the selector means is adapted to be arranged in a vehicle in such a way that the selector means can be operated by a driver of the vehicle while keeping the hands on the steering wheel of the vehicle.

6. A control device according to claim 1, wherein the selector means is adapted to be arranged in the steering column of a vehicle.

7. A control device according to claim 1, wherein the selector means is adapted to be arranged in the dashboard of a vehicle.

8. A control device according to claim 1, in that wherein the control device comprises a detector means arranged to sense the position of the selector means in the first operating region.

9. A control device according to claim 8, wherein the detector means is pneumatic.

10. A control device according to claim 8, wherein the detector means electrical.

11. A control device according to claim 1, wherein in addition to the gear positions and the parking brake position the control device comprises a further function selectable by means of the selector means.

12. A control device according to claim 11, wherein the selector means has a selectable position for operating a supplementary brake, such as a retarder brake.

13. A system for gear shift and parking brake actuation, comprising a parking brake actuating means and a control device according to claim 1.

14. A system according to claim 13, wherein the parking brake actuating means is adapted to be applied on one or more wheels of a vehicle so as to obtain the parking brake function.

15. A system according to claim 13, wherein the parking brake actuation means, when being in an activated condition, is released only if a service brake of the vehicle is applied.

16. A vehicle comprising a control device according to claim 1.

17. A vehicle comprising a system for gear shift and parking brake actuation, comprising a parking brake actuating means and a control device according to claim 1.
